(19) United States
(12) Patent Application Publication
(10) Pub. No.: US 2026/0237087 A1
(43) Pub. Date: Aug. 13, 2026

(54) IMAGE PROCESSING DEVICE AND IMAGE PROCESSING SYSTEM

(71) Applicant: SONY GROUP CORPORATION, TOKYO (JP)

(72) Inventors: HAJIME MIHARA, KANAGAWA (JP); TAKESHI UEMORI, KANAGAWA (JP); RYUTA SATOH, KANAGAWA (JP); YUSUKE MORIUCHI, TOKYO (JP)

(21) Appl. No.: 19/155,581

(22) PCT Filed: Feb. 7, 2024
(86) PCT No.: PCT/JP2024/004148

§ 371 Date: Aug. 12, 2025

(30) Foreign Application Priority Data
Feb. 22, 2023 (JP) 2023-026566

(51) Int. Cl. G06T 7/586; G06T 5/50; G06T 5/60; G06T 7/40; G06T 7/507; H04N 23/11; H04N 23/13; H04N 23/56; H04N 23/90

(52) U.S. Cl. CPC G06T 7/586; G06T 5/50; G06T 5/60; G06T 7/40; G06T 7/507; H04N 23/11; H04N 23/13; H04N 23/56; H04N 23/90; G06T 2207/10048; G06T 2207/20084

(57) ABSTRACT

The present disclosure relates to an image processing device and an image processing system that enable separation of an input image into a diffuse reflectance image and a shaded image with high accuracy. An image processing device includes: an input unit that receives, as inputs, a first wavelength band image obtained by imaging of a subject under an unknown light source environment including a first wavelength band, a second wavelength band image obtained by imaging of the subject under a known light source environment including a second wavelength band, and a distance image of the subject; a second wavelength diffuse reflectance estimation unit that estimates, from the second wavelength band image and the distance image, a second wavelength diffuse reflectance image that is a diffuse reflectance image of the subject with a light source in the second wavelength band; and a first wavelength diffuse reflectance and shade estimation unit that estimates a first wavelength diffuse reflectance image and a first wavelength shaded image that are a diffuse reflectance image and a shaded image of the subject with a light source including the first wavelength band on the basis of the second wavelength diffuse reflectance image and the first wavelength band image. The technology of the present disclosure can be applied to, for example, an image processing device or the like that separates a visible band image into a diffuse reflectance image and a shaded image.

### TECHNICAL FIELD

The present disclosure relates to an image processing device and an image processing system, and particularly relates to an image processing device and an image processing system enabled to separate an input image into a diffuse reflectance image and a shaded image with high accuracy.

### BACKGROUND ART

There is an intrinsic image decomposition technology for separating an input image into a diffuse reflectance image and a shaded image. For example, Non-Patent Document 1 discloses a technology for estimating a reflectance image and a shaded image by using a convolutional neural network (hereinafter referred to as CNN). The CNN configures an encoder that converts an input image into a feature amount vector in a stepwise manner and a decoder that converts the feature amount vector into a diffuse reflectance image and a shaded image. Non-Patent Document 2 discloses a technology for estimating a diffuse reflectance image by using images with and without flash of visible light. Furthermore, there is a disclosure of a means for generating an image in which influence of a shadow generated by ambient light is eliminated in an invisible band by using an indirect time-of-flight (iToF) sensor (Non-Patent Document 3), and there is a technology for estimating a diffuse reflectance image of a face by using the CNN by using two pairs of images obtained by an RGB sensor with visible light and an infrared sensor with infrared light (Non-Patent Document 4). As a means for removing influence of disturbance light, Patent Document 1 discloses a technology for removing the influence of the disturbance light by emitting light in a first wavelength range and light in a second wavelength range to a target object, and calculating a difference between pixel values of an image of the target object imaged in a state of being illuminated by the light in the first wavelength range and an image of the target object imaged in a state of not being illuminated by the light, and a difference between pixel values of an image of the target object imaged in a state of being illuminated by the light in the second wavelength range and the image of the target object imaged in a state of not being illuminated by the light.

### CITATION LIST

### Patent Document

Patent Document 1: Japanese Patent Application Laid-Open No. 2006-242909

### Non-Patent Document

Non-Patent Document 1: Narihira et al., Direct Intrinsics: Learning Albedo-Shading Decomposition by Convolutional Regression, CVPR 2015
Non-Patent Document 2: Cao et al., Stereoscopic Flash and No-Flash Photography for Shape and Albedo Recovery, CVPR 2020
Non-Patent Document 3: Adam et al., Bayesian Time-of-Flight for Realtime Shape, Illumination and Albedo, TPAMI 2016
Non-Patent Document 4: Xia et al., A Dark Flash Normal Camera, ICCV, 2021

### SUMMARY OF THE INVENTION

### Problems to be Solved by the Invention

Intrinsic image decomposition is essentially an ill-posed problem of obtaining two variables of diffuse reflectance and shade from one input image, and a solution is not uniquely determined. For that reason, there is still room for improvement in the technology for separating the input image into the diffuse reflectance image and the shaded image, and a technology is expected for separating the diffuse reflectance image and the shaded image with high accuracy.

The present disclosure has been made in view of such a situation, and is to enable separation of an input image into a diffuse reflectance image and a shaded image with high accuracy.

### Solutions to Problems

An image processing device according to a first aspect of the present disclosure includes:
an input unit that receives, as inputs, a first wavelength band image obtained by imaging of a subject under an unknown light source environment including a first wavelength band, a second wavelength band image obtained by imaging of the subject under a known light source environment including a second wavelength band, and a distance image of the subject;
a second wavelength diffuse reflectance estimation unit that estimates, from the second wavelength band image and the distance image, a second wavelength diffuse reflectance image that is a diffuse reflectance image of the subject with a light source in the second wavelength band; and
a first wavelength diffuse reflectance and shade estimation unit that estimates a first wavelength diffuse reflectance image and a first wavelength shaded image that are a diffuse reflectance image and a shaded image of the subject with a light source including the first wavelength band on the basis of the second wavelength diffuse reflectance image and the first wavelength band image.

In the first aspect of the present disclosure, the first wavelength band image obtained by imaging of the subject under the unknown light source environment including the first wavelength band, the second wavelength band image obtained by imaging of the subject under the known light source environment including the second wavelength band, and the distance image of the subject are received as inputs, the second wavelength diffuse reflectance image that is the diffuse reflectance image of the subject with the light source in the second wavelength band is estimated from the second wavelength band image and the distance image, and the first wavelength diffuse reflectance image and the first wavelength diffuse shaded image that are the diffuse reflectance image and the shaded image of the subject with the light source including the first wavelength band are estimated on the basis of the second wavelength diffuse reflectance image and the first wavelength band image.

An image processing system according to a second aspect of the present disclosure includes:
a first imaging device that images a subject under an unknown light source environment including a first wavelength band;
a second imaging device that images the subject under a known light source environment including a second wavelength band; and
an image processing device that estimates a first wavelength diffuse reflectance image and a first wavelength shaded image that are a diffuse reflectance image and a shaded image of the subject with a light source including the first wavelength band by using a first wavelength band image obtained by imaging of the subject by the first imaging device, a second wavelength band image obtained by imaging of the subject by the second imaging device, and a distance image of the subject.

In the second aspect of the present disclosure, the subject is imaged by the first imaging device under the unknown light source environment including the first wavelength band, and the subject is imaged by the second imaging device under the known light source environment including the second wavelength band. By use of the first wavelength band image captured by the first imaging device, the second wavelength band image captured by the second imaging device, and the distance image of the subject, the first wavelength diffuse reflectance image and the first wavelength shaded image are estimated that are the diffuse reflectance image and the shaded image of the subject with the light source including the first wavelength band.

Note that the image processing device of the present disclosure can be implemented by a computer to be caused to execute a program. In order to implement the image processing device, the program to be executed by the computer can be provided by being transmitted via a transmission medium or by being recorded on a recording medium.

The image processing device may be an independent device or an internal block constituting one device.

### BRIEF DESCRIPTION OF DRAWINGS

FIG. 1 is a block diagram illustrating a configuration example of a first embodiment of an image processing device of the present disclosure.

FIG. 2 is a block diagram illustrating a detailed configuration example of an invisible band diffuse reflectance estimation unit.

FIG. 3 is a block diagram illustrating a detailed configuration example of a visible band diffuse reflectance and shade estimation unit.

FIG. 4 is a flowchart illustrating processing executed by the image processing device.

FIG. 5 is a diagram illustrating a weight parameter wᵢⱼ.

FIG. 6 is a block diagram illustrating a configuration example of a first embodiment of an image processing system.

FIG. 7 is a flowchart illustrating input image generation processing of generating an input image to be input to the image processing device.

FIG. 8 is a flowchart illustrating details of imaging processing with invisible band light in step S32 in FIG. 7.

FIG. 9 is a block diagram illustrating a configuration example of a second embodiment of the image processing system.

FIG. 10 is a block diagram illustrating a configuration example of a third embodiment of the image processing system.

FIG. 11 is a block diagram illustrating a configuration example of a second embodiment of the image processing device of the present disclosure.

FIG. 12 is a block diagram illustrating a detailed configuration example of a visible band diffuse reflectance and shade estimation unit in FIG. 11.

FIG. 13 is a block diagram illustrating a configuration example of a third embodiment of the image processing device of the present disclosure.

FIG. 14 is a block diagram illustrating a detailed configuration example of an invisible band diffuse reflectance and surface roughness estimation unit in FIG. 13.

FIG. 15 is a block diagram illustrating a detailed configuration example of a material parameter and shade estimation unit in FIG. 13.

FIG. 16 is a block diagram illustrating a configuration example of a fourth embodiment of the image processing device of the present disclosure.

FIG. 17 is a block diagram illustrating a detailed configuration example of a material parameter and shade estimation unit in FIG. 16.

FIG. 18 is a block diagram illustrating a configuration example of an embodiment of a computer to which the technology of the present disclosure is applied.

### MODE FOR CARRYING OUT THE INVENTION

Hereinafter, modes for carrying out the technology of the present disclosure (hereinafter, referred to as embodiments) will be described with reference to the accompanying drawings. Note that, in the present specification and the drawings, constituent elements having substantially the same functional configurations will be denoted with the same reference signs, and redundant descriptions will be omitted. The description will be given in the following order.
1. First embodiment of image processing device
2. Flowchart of image processing device
3. First embodiment of image processing system
4. Flowchart of input image generation processing in image processing system
5. Second embodiment of image processing system
6. Third embodiment of image processing system
7. Second embodiment of image processing device
8. Third embodiment of image processing device
9. Fourth embodiment of image processing device
10. Conclusion
11. Configuration example of computer

### 1. FIRST EMBODIMENT OF IMAGE PROCESSING DEVICE

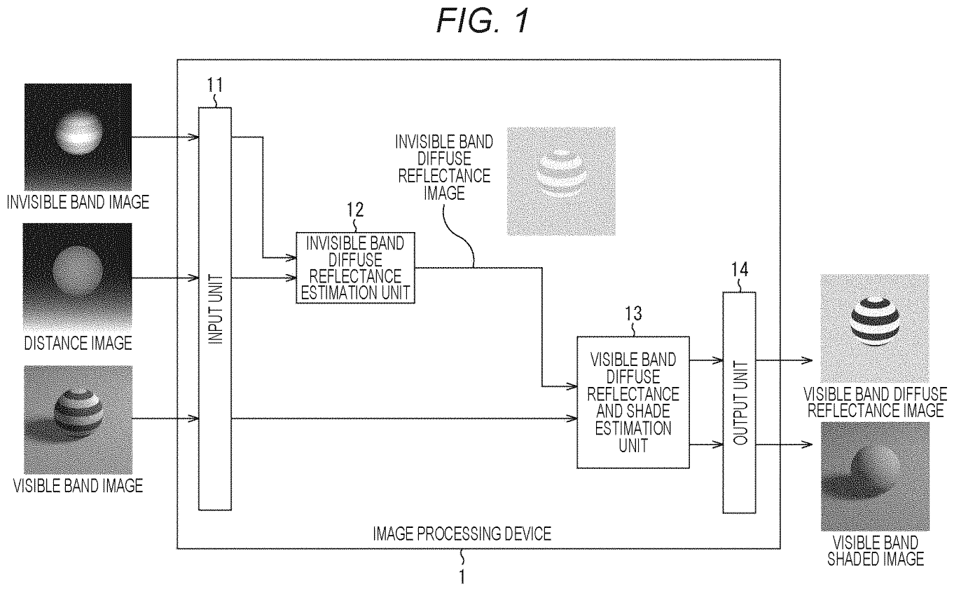

FIG. 1 is a block diagram illustrating a configuration example of a first embodiment of an image processing device of the present disclosure.

An image processing device 1 in FIG. 1 is a device that receives as inputs a visible band image of a subject captured with visible band light, separates the visible band image into a diffuse reflectance image and a shaded image, and outputs the images. The image processing device 1 receives as inputs an invisible band image obtained by imaging of the subject with invisible band light and a distance image of the subject, as guide information when the visible band image is separated into the diffuse reflectance image and the shaded image. The diffuse reflectance image is an image having a diffuse reflectance component (also referred to as an object color or albedo) of the subject as a pixel value, and the shaded image is an image having a shade component with a light source (illumination) or the like as a pixel value. The distance image is an image having a depth value that is distance information to the subject as a pixel value. Hereinafter, the output diffuse reflectance image is referred to as a visible band diffuse reflectance image, and the shaded image is referred to as a visible band shaded image.

In the present embodiment, the visible band light is light including an RGB wavelength band having a wavelength in a range of 400 to 700 nm, for example. The invisible band light is light including an infrared light wavelength band having a wavelength in a range of 780 to 1000 nm, for example. The invisible band image is an image obtained by illuminating of the subject only by a known light source such as a flash light without including ambient light. The known light source means that, for example, a three-dimensional position of the light source, a wavelength, emission intensity, and the like of light output from the light source are known.

The image processing device 1 includes an input unit 11, an invisible band diffuse reflectance estimation unit 12, a visible band diffuse reflectance and shade estimation unit 13, and an output unit 14.

The input unit 11 receives as inputs an invisible band image obtained by imaging of the subject under a known light source environment, a distance image of the subject, and a visible band image obtained by imaging of the subject under an unknown light source environment. The input unit 11 supplies the input invisible band image and distance image to the invisible band diffuse reflectance estimation unit 12, and supplies the input visible band image to the visible band diffuse reflectance and shade estimation unit 13.

The invisible band diffuse reflectance estimation unit 12 estimates (generates) an invisible band diffuse reflectance image, which is a diffuse reflectance image of the subject with the invisible band light, from the invisible band image and the distance image supplied from the input unit 11. The invisible band diffuse reflectance estimation unit 12 supplies the estimated invisible band diffuse reflectance image to the visible band diffuse reflectance and shade estimation unit 13.

The visible band diffuse reflectance and shade estimation unit 13 estimates (generates) a visible band diffuse reflectance image and a visible band shaded image on the basis of the visible band image supplied from the input unit 11 and the invisible band diffuse reflectance image supplied from the invisible band diffuse reflectance estimation unit 12. The visible band diffuse reflectance and shade estimation unit 13 supplies the estimated visible band diffuse reflectance image and visible band shaded image to the output unit 14. The output unit 14 outputs the visible band diffuse reflectance image and the visible band shaded image to the outside of the device.

The image processing device 1 configured as described above first generates the invisible band diffuse reflectance image of the subject from the invisible band image and the distance image of the subject. Next, the image processing device 1 generates the visible band diffuse reflectance image from the generated invisible band diffuse reflectance image and the input visible band image. By using the generated invisible band diffuse reflectance image as the guide information when generating the visible band diffuse reflectance image, the image processing device 1 can separate the input visible band image into the visible band diffuse reflectance image and the visible band shaded image with high accuracy. By using the invisible band diffuse reflectance image for processing of separation between the diffuse reflectance image and the shaded image in the visible band, it is possible to stably generate the visible band diffuse reflectance image.

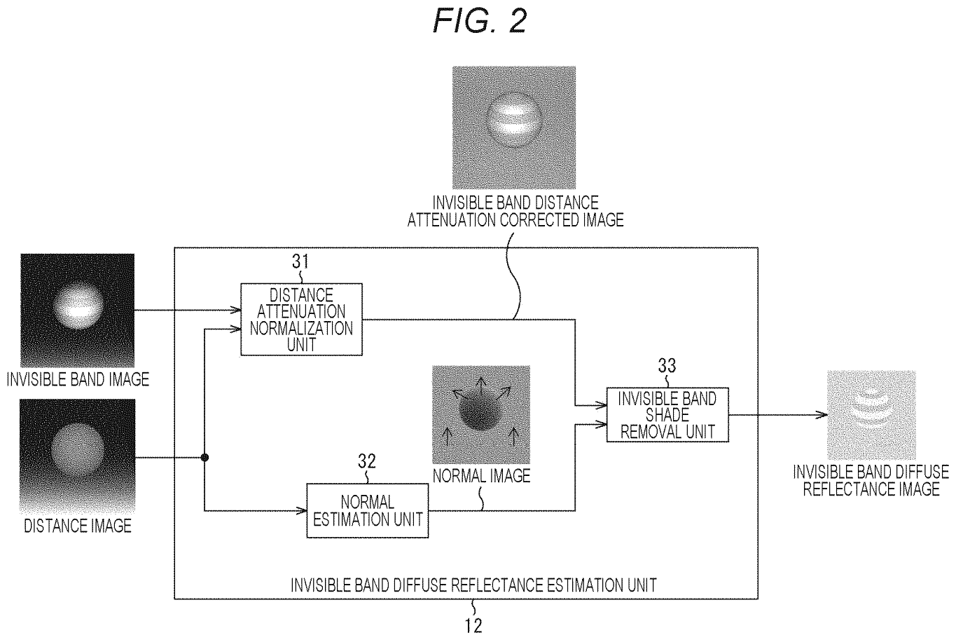

FIG. 2 is a block diagram illustrating a detailed configuration example of the invisible band diffuse reflectance estimation unit 12.

The invisible band diffuse reflectance estimation unit 12 includes a distance attenuation normalization unit 31, a normal estimation unit 32, and an invisible band shade removal unit 33.

The distance attenuation normalization unit 31 receives as inputs the invisible band image and the distance image. The distance attenuation normalization unit 31 generates an invisible band distance attenuation corrected image from the invisible band image and the distance image. The invisible band distance attenuation corrected image is an image obtained by correction of influence of distance attenuation with respect to the invisible band image. The invisible band image is an image of the subject illuminated only by a known light source such as a flash light. Since an amount of light from a light source is attenuated in inverse proportion to a square of a distance, the distance attenuation normalization unit 31 generates an image (Hereinafter, the image is referred to as the invisible band distance attenuation corrected image.) in which the influence of the distance attenuation is corrected by multiplication of a pixel value (luminance value) of the invisible band image by a square of a distance to the subject obtained from the distance image. The generated invisible band distance attenuation corrected image is supplied to the invisible band shade removal unit 33. In the invisible band distance attenuation corrected image, attenuation of light according to a distance is corrected, but there is a luminance change due to a difference in reflectance. In a case where it can be assumed that reflection in an imaged scene is diffuse reflection, the luminance change in the invisible band distance attenuation corrected image is caused only by a difference in invisible band reflectance, and attenuation due to a cosine of an angle formed by a normal direction of the subject and a light beam incident from the known light source.

The normal estimation unit 32 receives as an input a distance image. The normal estimation unit 32 estimates (generates) a normal image on the basis of the input distance image, and supplies the normal image to the invisible band shade removal unit 33. Any known method can be adopted for estimation of the normal image by using the distance image. For example, there are a method of converting a gradient of distance information into a normal line, a method using principal component analysis, and the like. As a method using principal component analysis, for example, as disclosed in a non-patent document “Surface reconstruction from unorganized points. In Proc. of ACM SIGGRAPH, 1992.”, there is a method of generating a point cloud from distance information and internal parameters of a camera, performing principal component analysis on a point cloud around a point of interest, and using a direction orthogonal to a principal component direction as a normal vector.

By using the normal image obtained by the normal estimation unit 32, the invisible band shade removal unit 33 removes shade generated by the angle formed by the normal direction and the light beam incident from the known light source from the invisible band distance attenuation corrected image obtained by the distance attenuation normalization unit 31. That is, in the luminance change in the invisible band distance attenuation corrected image caused by the difference in the invisible band reflectance and the attenuation due to (the cosine of) the angle formed by the normal direction of the subject and the light beam incident from the known light source, the invisible band shade removal unit 33 removes the attenuation due to the angle formed by the normal direction of the subject and the light beam incident from the known light source. The invisible band distance attenuation corrected image after the removal is an image having the luminance change only by the difference in the invisible band reflectance, that is, the invisible band diffuse reflectance image.

In general, in a case where it can be assumed that reflection on the subject is diffuse reflection, an observed luminance value I is expressed by Expression (1) below.

$$I = {A}_{invis} \cdot {I}_{L} \cdot L \cdot N \qquad ( 1 )$$

In Expression (1), Aᵢₙᵥᵢₛ represents reflectance in an invisible band, I_{L} represents intensity of invisible band light incident on an object surface of the subject, L represents a vector of a light source direction of infrared light (invisible light) viewed from the object surface of the subject, and N represents a normal line of the object surface of the subject.

The intensity I_{L} of the invisible band light incident on the object surface of the subject is attenuated in inverse proportion to a square of a distance d since the invisible band light currently illuminates the subject only by the known light source, and thus can be expressed as Expression (2) below.

$$\begin{matrix}I = {A}_{invis} \cdot {I}_{L} ( d ) \cdot L \cdot N \\ = {A}_{invis} \cdot \frac{{I}_{L}^{′}}{{d}^{2}} \cdot L \cdot N\end{matrix} \qquad ( 2 )$$

Here, I_{L}′ represents intensity of infrared light when the distance to the subject is 1. Since the distance attenuation normalization unit 31 that corrects attenuation of light according to the distance d multiplies the pixel value (luminance value) of the invisible band image by the square of the distance, a luminance value I₁ of the invisible band distance attenuation corrected image is expressed by Expression (3).

$${I}_{1} = {A}_{i nvis} \cdot {I}_{L}^{′} \cdot L \cdot N \qquad ( 3 )$$

A value obtained by division of both sides of Expression (3) by the vector L of the light source direction of the infrared light and the normal line N of the object surface of the subject is set as a reflectance Aᵢₙᵥᵢₛ′ as in Expression (4).

$$[ Math . 2 ]$$

$${A}_{invis}^{′} = {A}_{invis} \cdot {I}_{L}^{′} = \frac{{I}_{1}}{L \cdot N} \qquad ( 4 )$$

Since the luminance value I of the invisible band distance attenuation corrected image is calculated by the distance attenuation normalization unit 31, the vector L of the light source direction of the infrared light is known, and the normal line N of the object surface of the subject is calculated by the normal estimation unit 32, the reflectance Aᵢₙᵥᵢₛ′ can be calculated.

The reflectance Aᵢₙᵥᵢₛ′ corresponds to a value obtained by multiplication of the reflectance Aᵢₙᵥᵢₛ in the invisible band by the intensity (amount of light) I_{L}′ of the infrared light when an object distance is 1, that is, a value obtained by multiplication of the reflectance Aᵢₙᵥᵢₛ in the invisible band by a predetermined constant. Since the visible band diffuse reflectance and shade estimation unit 13 in the subsequent stage uses texture and edge information on the invisible band diffuse reflectance image, there is no problem even if the invisible band diffuse reflectance image to be output is not an image having the reflectance Aᵢₙᵥᵢₛ in the invisible band as a pixel value, but is an image having the reflectance Aᵢₙᵥᵢₛ′ obtained by multiplication of the reflectance Aᵢₙᵥᵢₛ in the invisible band by the predetermined constant as a pixel value. In a case where it is desired to output the invisible band diffuse reflectance image having the reflectance Aᵢₙᵥᵢₛ in the invisible band as a pixel value, for example, it is sufficient that the intensity I_{L}′ of the infrared light when the subject distance is 1 is obtained in advance by calibration, and an image is output in which a value obtained by division by Aᵢₙᵥᵢₛ′/I_{L}′ is stored as a pixel value.

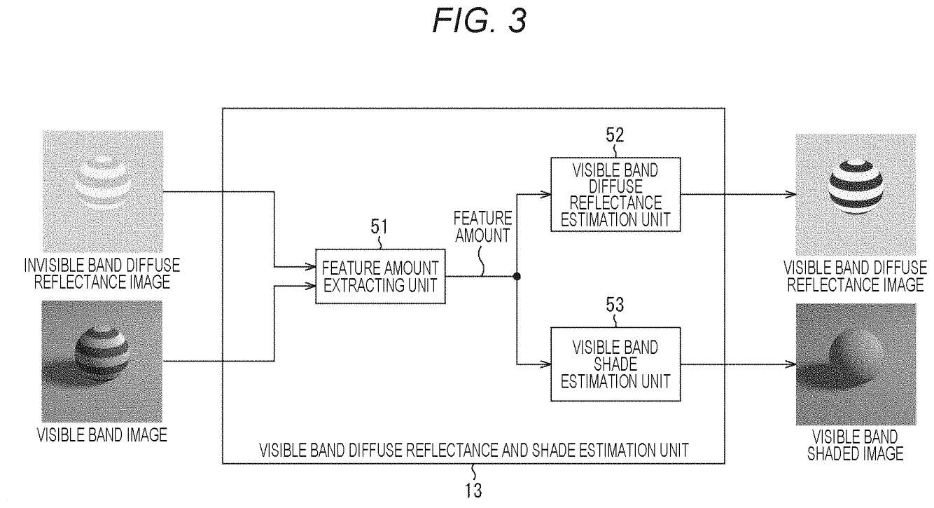

FIG. 3 is a block diagram illustrating a detailed configuration example of the visible band diffuse reflectance and shade estimation unit 13.

The visible band diffuse reflectance and shade estimation unit 13 includes a feature amount extraction unit 51, a visible band diffuse reflectance estimation unit 52, and a visible band shade estimation unit 53. The visible band diffuse reflectance and shade estimation unit 13 is supplied with the visible band image from the input unit 11, and is supplied with the invisible band diffuse reflectance image from the invisible band diffuse reflectance estimation unit 12.

The feature amount extraction unit 51 extracts a feature amount of the images from the invisible band diffuse reflectance image and the visible band image, and supplies the feature amount to the visible band diffuse reflectance estimation unit 52 and the visible band shade estimation unit 53. The visible band diffuse reflectance estimation unit 52 estimates (generates) the visible band diffuse reflectance image on the basis of the supplied feature amount, and supplies the visible band diffuse reflectance image to the output unit 14. The visible band shade estimation unit 53 estimates (generates) the visible band shaded image on the basis of the supplied feature amount, and supplies the visible band shaded image to the output unit 14.

The visible band diffuse reflectance and shade estimation unit 13 can be implemented by a CNN predictor using a CNN (convolutional neural network). The CNN includes, for example, an encoder including a plurality of stages of a convolution layer and a pooling layer and executing filtering processing and downsampling processing, and a decoder including a plurality of stages of a deconvolution layer and a depooling layer and executing filtering processing and upsampling processing. In a case where the visible band diffuse reflectance and shade estimation unit 13 is implemented by the CNN predictor, the feature amount extraction unit 51 corresponds to an encoder that extracts a feature amount, and the visible band diffuse reflectance estimation unit 52 and the visible band shade estimation unit 53 correspond to a decoder that generates an image based on the extracted feature amount. In learning processing for the CNN predictor, parameters of the CNN predictor are learned by use of teacher images for the visible band diffuse reflectance image and the visible band shaded image generated by computer graphics (CG) or the like, for example.

### 2. FLOWCHART OF IMAGE PROCESSING DEVICE

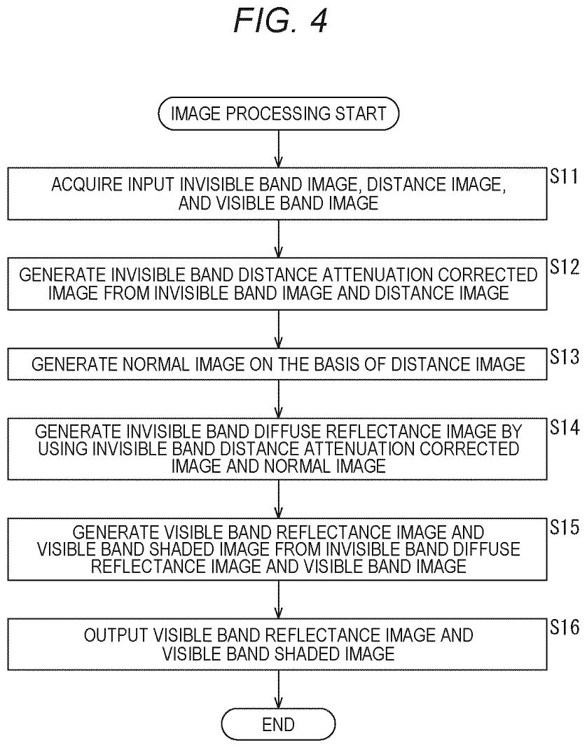

Next, with reference to a flowchart in FIG. 4, a description will be given of processing (image processing) of separating a visible band image into a visible band diffuse reflectance image and a visible band shaded image, which is executed by the image processing device 1 of the first embodiment. This processing is started, for example, when the invisible band image, the distance image, and the visible band image are input to the image processing device 1.

First, in step S11, the input unit 11 acquires the input invisible band image, distance image, and visible band image. The input unit 11 supplies the invisible band image and the distance image to the invisible band diffuse reflectance estimation unit 12, and supplies the visible band image to the visible band diffuse reflectance and shade estimation unit 13.

In step S12, the distance attenuation normalization unit 31 of the invisible band diffuse reflectance estimation unit 12 generates an invisible band distance attenuation corrected image from the invisible band image and the distance image. More specifically, the distance attenuation normalization unit 31 generates the invisible band distance attenuation corrected image by multiplying the pixel value (luminance value) of the invisible band image by the square of the distance to the subject obtained from the distance image. The generated invisible band distance attenuation corrected image is supplied to the invisible band shade removal unit 33.

In step S13, the normal estimation unit 32 generates a normal image on the basis of the distance image supplied from the input unit 11, and supplies the normal image to the invisible band shade removal unit 33. The processing of steps S12 and S13 can be executed in parallel (simultaneously).

In step S14, the invisible band shade removal unit 33 uses the invisible band distance attenuation corrected image obtained by the distance attenuation normalization unit 31 and the normal image obtained by the normal estimation unit 32 to remove shade generated by the angle formed by the normal direction and the light beam incident from the known light source by Expression (4) described above, and generates an invisible band diffuse reflectance image. The generated invisible band diffuse reflectance image is supplied to the visible band diffuse reflectance and shade estimation unit 13.

In step S15, the visible band diffuse reflectance and shade estimation unit 13 generates a visible band diffuse reflectance image and a visible band shaded image from the invisible band diffuse reflectance image supplied from the invisible band shade removal unit 33 and the visible band image supplied from the input unit 11. The generated visible band diffuse reflectance image and visible band shaded image are supplied to the output unit 14.

In step S16, the output unit 14 outputs the visible band diffuse reflectance image and the visible band shaded image to the outside of the device, and the processing ends.

As described above, according to the processing of separating the visible band image into the visible band diffuse reflectance image and the visible band shaded image executed by the image processing device 1 of the first embodiment, it is possible to generate the invisible band diffuse reflectance image of the subject from the invisible band image and the distance image of the subject, and to separate and generate the visible band diffuse reflectance image and the visible band shaded image by using the generated invisible band diffuse reflectance image as the guide information. By using the invisible band diffuse reflectance image as the guide information, it is possible to stably generate the visible band diffuse reflectance image.

<Calculation Method without Using CNN>

In the above-described example, an example of generating (separating) the visible band diffuse reflectance image and the visible band shaded image by using the CNN has been described as the processing by the visible band diffuse reflectance and shade estimation unit 13; however, the visible band diffuse reflectance image and the visible band shaded image can be generated even in a configuration without using the CNN. Hereinafter, a description will be given of a method of generating a visible band diffuse reflectance image and a visible band shaded image without using the CNN.

For example, the visible band diffuse reflectance and shade estimation unit 13 can perform calculation on the basis of a condition that relationships between pixel values of adjacent pixels are close to each other between the invisible band diffuse reflectance image and the visible band diffuse reflectance image. Specifically, when a pixel value at a pixel position i of the visible band image is Iᵢ^{vis}, and a pixel value at the pixel position i of the invisible band diffuse reflectance image estimated by the invisible band diffuse reflectance estimation unit 12 is Aᵢ^{Invis}, and pixel values at the pixel position i of the visible band diffuse reflectance image and the visible band shaded image to be obtained are respectively A″ᵢ^{Vis} and S″ᵢ^{Vis}, it is possible to generate the visible band diffuse reflectance image and the visible band shaded image by calculating the pixel value A″ᵢ^{Vis} of the visible band diffuse reflectance image and the pixel value S″ᵢ^{Vis} of the visible band shaded image that minimizes a cost function of Expression (5) by a sequential least squares method or the like, for example.

$$[ Math . 3 ]$$

$${A}_{i}^{′′ Vis} , {S}_{i}^{′′ Vis} = arg {min}_{{A}_{i}^{Vis} , {S}_{i}^{Vis}} \{ {\sum }_{i ∈ P} {\sum }_{j ∈ N ( i )} {( {A}_{i}^{Vis} - {w}_{ij} \cdot {A}_{j}^{Vis} )}^{2} + {\sum }_{i ∈ P} {( \frac{{I}_{i}^{Vis}}{{S}_{i}^{Vis}} - {A}_{i}^{Vis} )}^{2} \} . \qquad ( 5 )$$

In Expression (5), j represents a pixel position near the pixel position i. Furthermore, wᵢⱼ is a weight parameter using an invisible band diffuse reflectance image A^{Invis}, and is expressed by Expression (6).

$$[ Math . 4 ]$$

$${w}_{ij} = exp ( - \frac{{( {A}_{i}^{Invis} - {A}_{j}^{Invis} )}^{2}}{2 {σ}_{I}^{2}} ) \qquad ( 6 )$$

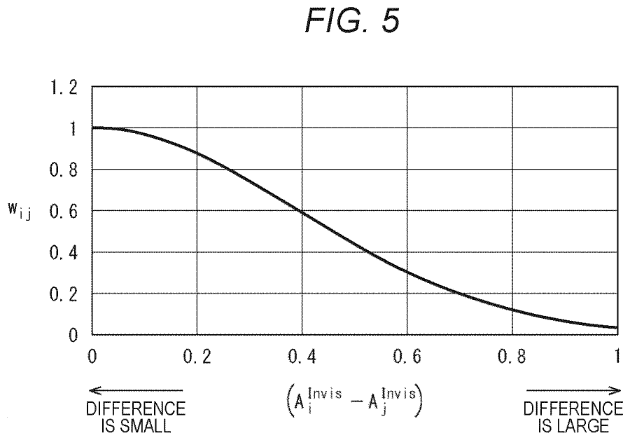

FIG. 5 illustrates the weight parameter wᵢⱼ of Expression (6). The weight parameter wᵢⱼ takes a larger value as a difference between the pixel value Aᵢ^{Invis} at the pixel position i and a pixel value Aⱼ^{Invis} at the pixel position j is smaller in a range from 0 to 1. In the invisible band diffuse reflectance image A^{Invis}, in a case where the pixel value Aᵢ^{Invis} at the pixel position i and the pixel value Aⱼ^{Invis} at the pixel position j are close values, the weight parameter wᵢⱼ has an effect of making the pixel value Aᵢ^{Vis} at the pixel position i and the pixel value Aᵢ^{Vis} at the pixel position j of the visible band diffuse reflectance image also close values.

### 3. FIRST EMBODIMENT OF IMAGE PROCESSING SYSTEM

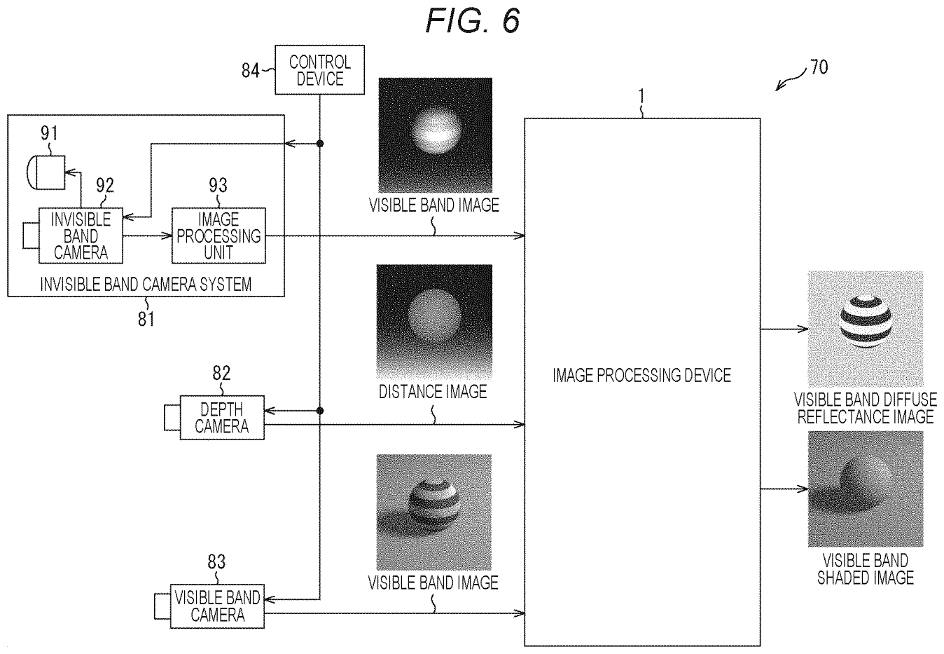

FIG. 6 is a block diagram illustrating a configuration example of a first embodiment of an image processing system including the image processing device 1 in FIG. 1.

An image processing system 70 illustrated in FIG. 6 includes an invisible band camera system 81, a depth camera 82, a visible band camera 83, and a control device 84 in addition to the image processing device 1 in FIG. 1.

The invisible band camera system 81 images a subject with invisible band light on the basis of an imaging start trigger from the control device 84, and outputs an invisible band image to the image processing device 1. The invisible band camera system 81 includes an invisible band light source 91, an invisible band camera 92, and an image processing unit 93. An environment in which the invisible band camera system 81 images the subject is an environment in which there is ambient light.

The invisible band light source 91 emits invisible band light to the subject on the basis of control of the invisible band camera 92. A three-dimensional position of the invisible band light source 91, a wavelength of light emitted from the invisible band light source 91, an emission intensity, and the like are known. The invisible band camera 92 includes, for example, an infrared camera that receives infrared light in an invisible band, generates an invisible band image, and outputs the invisible band image to the image processing unit 93. Specifically, the invisible band camera 92 outputs a first invisible band image obtained by imaging of the subject without emission of the invisible band light of the invisible band light source 91 and a second invisible band image obtained by imaging of the subject with emission of the invisible band light to the image processing unit 93. The image processing unit 93 calculates a difference between the first invisible band image obtained by imaging of the subject without emission of the invisible band light of the invisible band light source 91 and the second invisible band image obtained by imaging of the subject with emission of the invisible band light, and generates an invisible band image not including an ambient light component. The image processing unit 93 outputs the generated invisible band image to the image processing device 1.

In order to generate the invisible band image not including the ambient light component under the environment where there is the ambient light, the invisible band camera system 81 performs imaging twice to generate the first invisible band image in a state where the invisible band light is not emitted to the subject and the second invisible band image in a state where the invisible band light is emitted to the subject. In a case where an imaging environment is an environment where there is no ambient light, one imaging is sufficient in which the invisible band light is emitted to the subject, and it is also possible to omit the image processing unit 93.

The depth camera 82 generates a distance image of the subject on the basis of the imaging start trigger from the control device 84, and outputs the distance image to the image processing device 1. As a method for imaging the subject by the depth camera 82, for example, any method can be adopted such as a stereo camera method, a structured light method, or a time of flight (ToF) method.

The visible band camera 83 includes an RGB camera that receives light including an RGB wavelength band, generates a color image on the basis of the imaging start trigger from the control device 84, and outputs the color image as a visible band image to the image processing device 1.

The control device 84 controls overall operation of the image processing system 70. For example, the control device 84 generates the imaging start trigger for executing imaging as an imaging control signal, and outputs the imaging start trigger to the invisible band camera system 81, the depth camera 82, and the visible band camera 83. The imaging start trigger is adjusted so that imaging by other devices is not affected by invisible band light of the invisible band light source 91 of the invisible band camera system 81 or active light in a case where the depth camera 82 emits infrared light or the like as the active light. The control device 84 may not be an independent device but may be incorporated as a part of a device such as the invisible band camera system 81 or the image processing device 1.

The image processing device 1 acquires the invisible band image input from the invisible band camera system 81, the distance image input from the depth camera 82, and the visible band image input from the visible band camera 83, and executes the image processing described in the flowchart in FIG. 4, that is, processing of separating the visible band image into the visible band diffuse reflectance image and the visible band shaded image.

### 4. FLOWCHART OF INPUT IMAGE GENERATION PROCESSING IN IMAGE PROCESSING SYSTEM

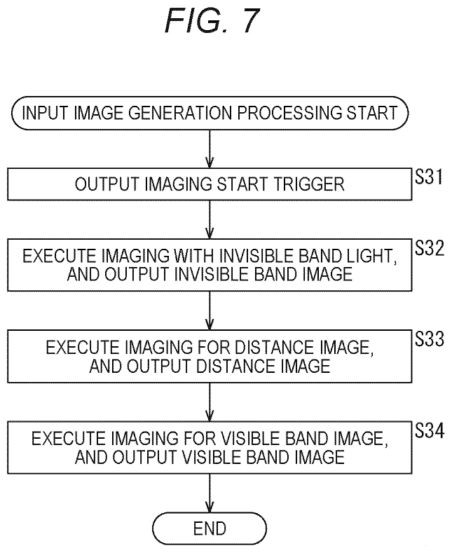

Next, with reference to the flowchart in FIG. 7, a description will be given of input image generation processing of generating an input image to be input to the image processing device 1 by the invisible band camera system 81, the depth camera 82, and the visible band camera 83. This processing is started, for example, when a user gives an instruction to start imaging in the control device 84.

First, in step S31, the control device 84 generates an imaging start trigger for executing imaging as an imaging control signal, and outputs the imaging start trigger to the invisible band camera system 81, the depth camera 82, and the visible band camera 83. The imaging start trigger is output such that imaging timings of the invisible band camera system 81, the depth camera 82, and the visible band camera 83 are shifted from each other by a minute time, for example, so that the active light does not affect the imaging by other devices.

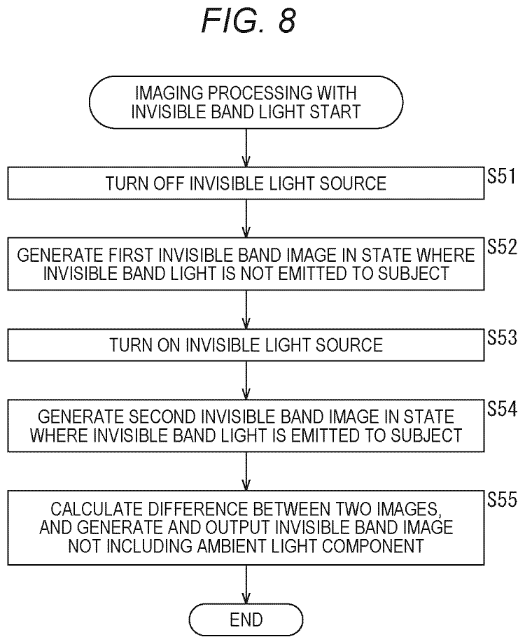

In step S32, the invisible band camera system 81 acquires the imaging start trigger from the control device 84, executes imaging with invisible band light, generates an invisible band image not including an ambient light component, and outputs the invisible band image to the image processing device 1. Detailed processing in step S32 will be described later with reference to a flowchart of FIG. 8.

In step S33, the depth camera 82 executes imaging for a distance image on the basis of the imaging start trigger from the control device 84, generates a distance image of the subject, and outputs the distance image to the image processing device 1.

In step S34, the visible band camera 83 executes imaging for a visible band image on the basis of the imaging start trigger from the control device 84, and outputs the visible band image (color image) to the image processing device 1.

Thus, the input image generation processing ends. Some or all of the processing of steps S32, S33, and S34 may be executed in parallel. However, it is necessary to perform control so that the active light does not affect imaging by other devices.

FIG. 8 is a flowchart illustrating details of imaging processing with the invisible band light in step S32 in FIG. 7.

In the processing in FIG. 8, first, the invisible band camera 92 controls the invisible band light source 91 to be turned off in step S51, executes imaging in step S52, generates a first invisible band image in a state where the invisible band light is not emitted to the subject, and outputs the first invisible band image to the image processing unit 93.

Next, the invisible band camera 92 controls the invisible band light source 91 to be turned on in step S53, executes imaging in step S54, generates a second invisible band image in a state where the invisible band light is emitted to the subject, and outputs the second invisible band image to the image processing unit 93.

In step S55, the image processing unit 93 calculates a difference between two images of the first invisible band image obtained by imaging of the subject without emission of the invisible band light and the second invisible band image obtained by imaging of the subject with emission of the invisible band light, generates an invisible band image not including an ambient light component, and outputs the invisible band image to the image processing device 1, and the processing in FIG. 8 ends.

### 5. SECOND EMBODIMENT OF IMAGE PROCESSING SYSTEM

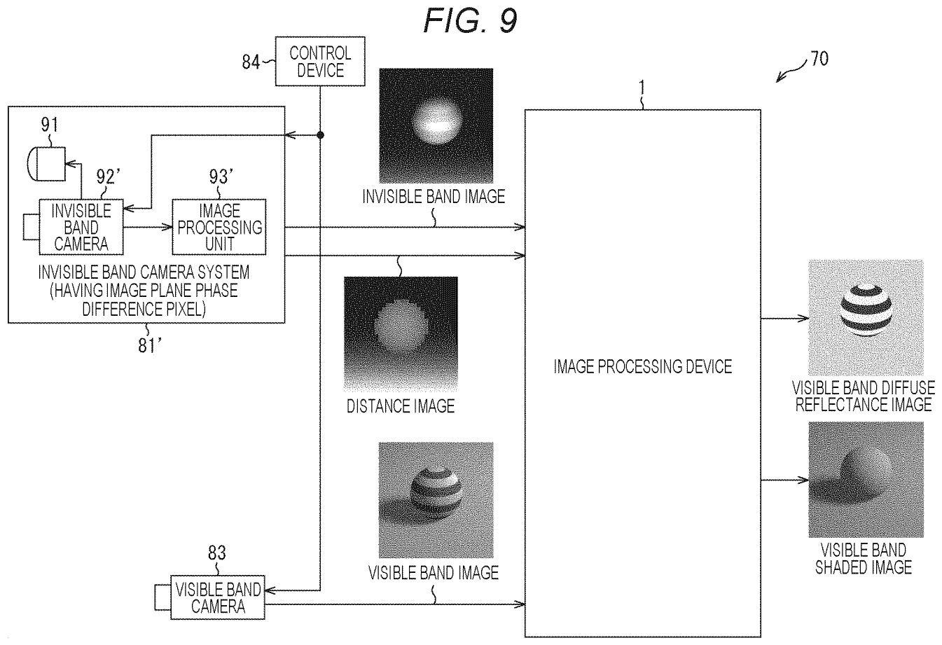

FIG. 9 is a block diagram illustrating a configuration example of a second embodiment of the image processing system including the image processing device 1 in FIG. 1.

In FIG. 9, parts common to those of the image processing system of the first embodiment illustrated in FIG. 6 are denoted with the same reference signs, and descriptions of the parts will be omitted as appropriate.

The image processing system 70 illustrated in FIG. 9 includes an invisible band camera system 81′, the visible band camera 83, and the control device 84 in addition to the image processing device 1 in FIG. 1. Thus, when the image processing system 70 of the second embodiment in FIG. 9 is compared with the image processing system 70 of the first embodiment in FIG. 6, the depth camera 82 is omitted, and the invisible band camera system 81 is changed to the invisible band camera system 81′.

In the image processing system 70 of the second embodiment, the invisible band camera system 81′ generates an invisible band image and a distance image and outputs the invisible band image and the distance image to the image processing device 1. The invisible band camera system 81′ includes the invisible band light source 91, an invisible band camera 92′, and an image processing unit 93′.

The invisible band camera 92′ is a camera including, in a pixel array unit that receives invisible band light, an imaging pixel (normal pixel) that outputs an imaging signal according to an amount of received light, and a phase difference pixel (image plane phase difference pixel) that outputs a phase difference signal. The phase difference pixel is a pixel that shields a part of a light receiving region (performs pupil division) and can detect a distance to the subject (focus position) on the basis of a signal difference (phase difference) between two phase difference pixels whose light shielding regions are symmetric with each other. The number of pixels of the phase difference pixel arranged in the pixel array unit is smaller than that of the imaging pixel.

Similarly to the image processing unit 93 of the first embodiment, the image processing unit 93′ generates an invisible band image that is an image of a subject illuminated only by the known invisible band light source 91 not including ambient light, by using a pixel signal of an imaging pixel, and outputs the invisible band image to the image processing device 1. A pixel signal of a phase difference pixel portion is generated by interpolation processing or the like. Furthermore, the image processing unit 93′ generates a distance image of the subject by using the pixel signal of the phase difference pixel and outputs the distance image to the image processing device 1. The distance image using the pixel signal of the phase difference pixel is an image whose resolution is low. The image processing unit 93′ executes resolution conversion processing for improving the resolution of the distance image, and generates and outputs a high-resolution distance image to the image processing device 1. As the resolution conversion processing, for example, the technology disclosed in WO 2020/209040 can be used that improves the resolution by referring to the invisible band image, or the visible band image generated by the visible band camera 83.

The image processing system 70 of the second embodiment is configured as described above. In the example in FIG. 9, an example has been described in which the invisible band camera 92′ includes a camera including phase difference pixels in a part of the pixel array unit. However, the camera including phase difference pixels in a part of the pixel array unit may be the visible band camera 83 instead of the invisible band camera 92′. In this case, the visible band camera 83 generates a visible band image and a distance image, and outputs the visible band image and the distance image to the image processing device 1. The resolution conversion processing for improving the resolution of the distance image is also appropriately executed.

### 6. THIRD EMBODIMENT OF IMAGE PROCESSING SYSTEM

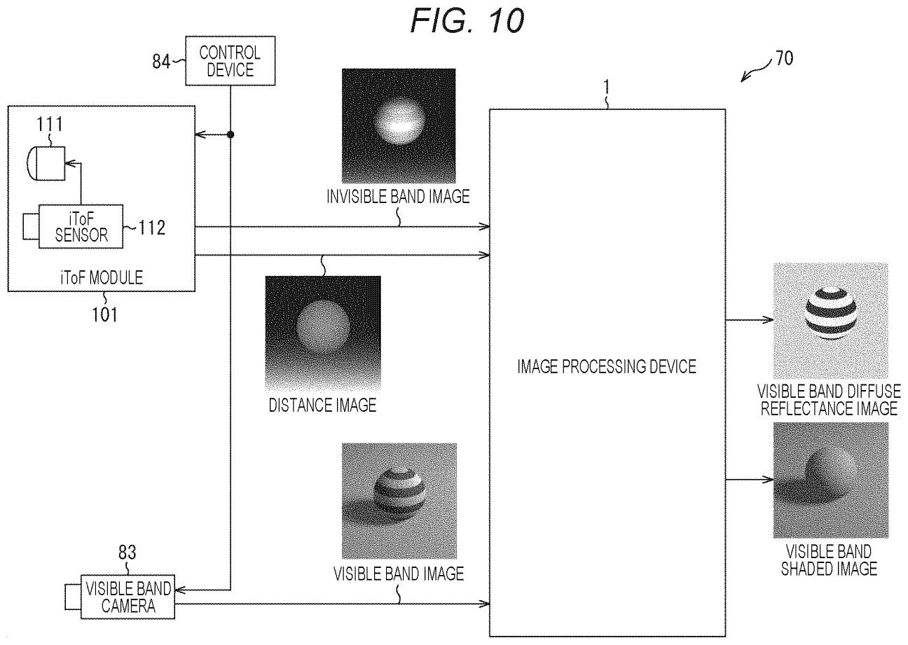

FIG. 10 is a block diagram illustrating a configuration example of a third embodiment of the image processing system including the image processing device 1 in FIG. 1.

Also in FIG. 10, parts common to those of the image processing system of the first embodiment illustrated in FIG. 6 are denoted with the same reference signs, and descriptions of the parts will be omitted as appropriate.

The image processing system 70 illustrated in FIG. 10 includes an iToF module 101, the visible band camera 83, and the control device 84 in addition to the image processing device 1 in FIG. 1. Thus, when the image processing system 70 of the third embodiment in FIG. 10 is compared with the image processing system 70 of the first embodiment in FIG. 6, the invisible band camera system 81 and the depth camera 82 are changed to the iToF module 101.

The iToF module 101 is a distance measurement module capable of calculating the distance to the subject by an indirect ToF method, and includes an invisible band light source 111 and an iToF sensor 112. The invisible band light source 111 emits, for example, infrared light in which on (High) and off (Low) are repeated at a modulation frequency f on the basis of the control of the iToF sensor 112. The iToF sensor 112 generates a distance image obtained by calculating the distance to the subject and an invisible band image obtained by calculating the luminance of the subject, for example, by a 4Phase method, and outputs the distance image and the invisible band image to the image processing device 1. The 4Phase method is a detection method in which reflected light is received at light receiving timings with phases shifted by just 0°, 90°, 180°, and 270° with respect to an irradiation timing of irradiation light as a reference. In the 4Phase method, the iToF sensor 112 receives the reflected light by changing the phase in a time division manner such that the phase is set to 0° with respect to the irradiation timing of the irradiation light and the reflected light is received in a certain frame period, the phase is set to 90° and the reflected light is received in the next frame period, the phase is set to 180° and the reflected light is received in the next frame period, and the phase is set to 270° and the reflected light is received in the next frame period.

In the indirect ToF method, a depth value d can be obtained by Expression (7) below. Furthermore, an intensity C of the received reflected light can be obtained by Expression (8) below.

$$[ Math . 5 ]$$

$$d = \frac{c}{4 π f} {tan}^{- 1} \frac{{I}_{90} - {I}_{270}}{{I}_{0} - {I}_{180}} \qquad ( 7 )$$

$$C = \sqrt{{( {I}_{0} - {I}_{180} )}^{2} + {( {I}_{90} - {I}_{270} )}^{2}} \qquad ( 8 )$$

In Expression (7), c represents the speed of light, and f represents the modulation frequency of the irradiation light. Furthermore, I₀, I₉₀, I₁₈₀, and I₂₇₀ represent detection signals (pixel signals) obtained by setting of the phases to 0°, 90°, 180°, and 270°. The intensity C corresponds to the magnitude of the reflected light received by the pixel, that is, luminance information (luminance value).

Although the detection signals I₀, I₉₀, I₁₈₀, and I₂₇₀ may include the ambient light component, since the ambient light component is removed in a process of calculating differences of (I₉₀−I₂₇₀) and (I₀−I₁₈₀), the intensity C is a signal that is not affected by the ambient light even in a case where there is the ambient light component in the imaging environment. A detailed description of the 4Phase method of indirect ToF is disclosed in, for example, Japanese Patent Application Laid-Open No. 2020-173128.

The iToF module 101 generates a distance image having the depth value d of Expression (7) as a pixel value, generates an invisible band image having the intensity C of Expression (8) as a pixel value, and outputs the distance image and the invisible band image to the image processing device 1. The iToF module 101 is used, whereby calculation (image processing) of removing the ambient light component from the two images becomes unnecessary, and the invisible band image and the distance image can be generated simultaneously. Compared with the image processing system of the first embodiment, the number of cameras is reduced, and imaging can be more easily executed to acquire the invisible band image and the distance image.

Note that the image processing system 70 is not limited to the first to third embodiments described above, and may be implemented by other configurations as long as three types of images of an invisible band image, a distance image, and a visible band image can be acquired and input to the image processing device 1.

### 7. SECOND EMBODIMENT OF IMAGE PROCESSING DEVICE

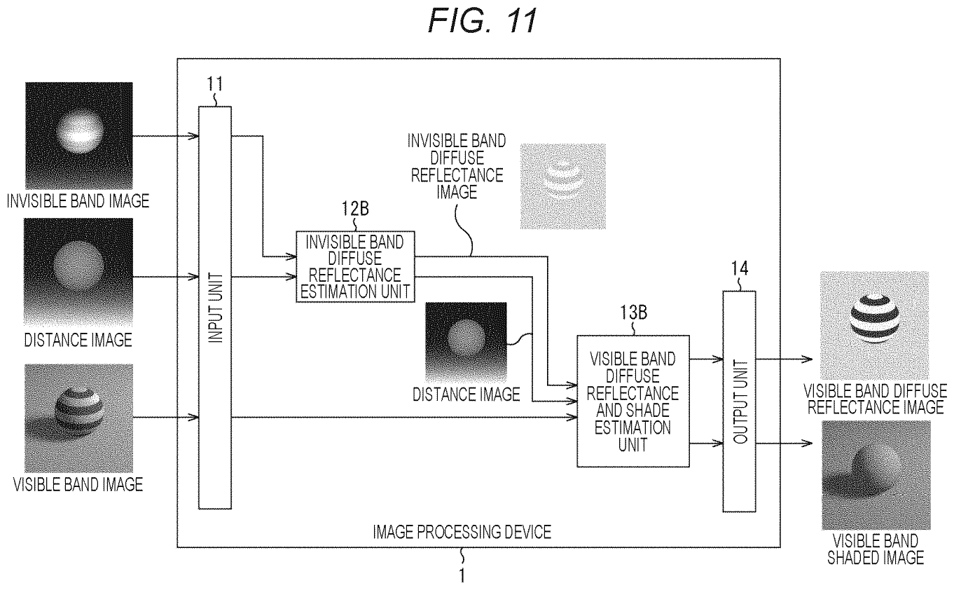

FIG. 11 is a block diagram illustrating a configuration example of a second embodiment of the image processing device of the present disclosure.

In FIG. 11, parts common to those of the image processing device of the first embodiment illustrated in FIG. 1 are denoted with the same reference signs, and descriptions of the parts will be omitted as appropriate.

In the image processing device 1 illustrated in FIG. 11, as compared with the first embodiment illustrated in FIG. 1, the invisible band diffuse reflectance estimation unit 12 and the visible band diffuse reflectance and shade estimation unit 13 are changed to an invisible band diffuse reflectance estimation unit 12B and a visible band diffuse reflectance and shade estimation unit 13B.

The invisible band diffuse reflectance estimation unit 12B is common to the invisible band diffuse reflectance estimation unit 12 in that the invisible band diffuse reflectance image is generated from the input invisible band image and distance image. In addition, the invisible band diffuse reflectance estimation unit 12B is different from the invisible band diffuse reflectance estimation unit 12 in that the input distance image is output to the visible band diffuse reflectance and shade estimation unit 13B.

The visible band diffuse reflectance and shade estimation unit 13B estimates (generates) the visible band diffuse reflectance image and the visible band shaded image on the basis of the visible band image supplied from the input unit 11 and the invisible band diffuse reflectance image and the distance image supplied from the invisible band diffuse reflectance estimation unit 12B. That is, the visible band diffuse reflectance and shade estimation unit 13B is different from the invisible band diffuse reflectance estimation unit 12 in that the visible band diffuse reflectance image and the visible band shaded image are generated by use of not only the invisible band diffuse reflectance image and the visible band image but also the distance image.

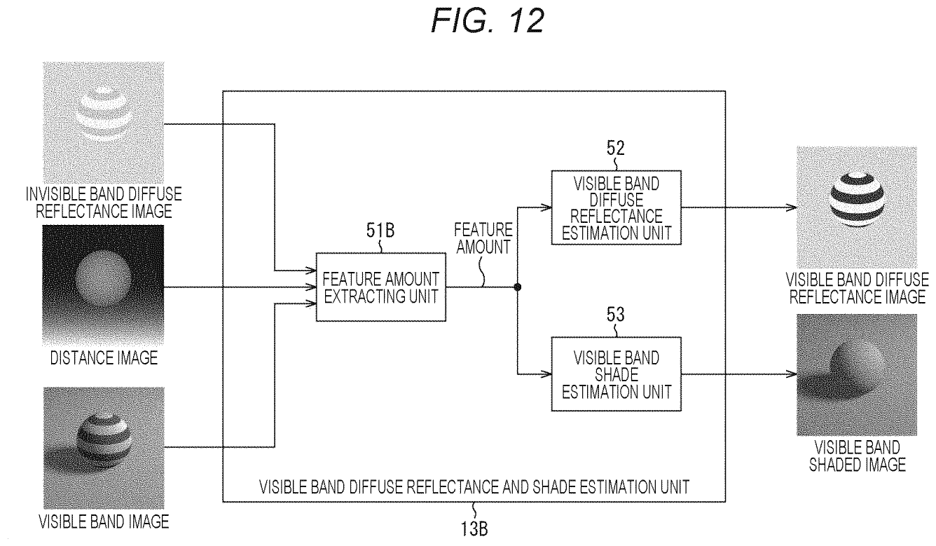

FIG. 12 is a block diagram illustrating a detailed configuration example of the visible band diffuse reflectance and shade estimation unit 13B.

The visible band diffuse reflectance and shade estimation unit 13B includes a feature amount extraction unit 51B, the visible band diffuse reflectance estimation unit 52, and the visible band shade estimation unit 53. Thus, as compared with the visible band diffuse reflectance and shade estimation unit 13 of the first embodiment illustrated in FIG. 3, the feature amount extraction unit 51B is changed.

The feature amount extraction unit 51B is supplied with the visible band image from the input unit 11, and is supplied with the invisible band diffuse reflectance image and the distance image from the invisible band diffuse reflectance estimation unit 12B.

The feature amount extraction unit 51B extracts a feature amount of the images from the invisible band diffuse reflectance image, the distance image, and the visible band image, and supplies the feature amount to the visible band diffuse reflectance estimation unit 52 and the visible band shade estimation unit 53. The visible band diffuse reflectance estimation unit 52 estimates (generates) the visible band diffuse reflectance image on the basis of the supplied feature amount, and supplies the visible band diffuse reflectance image to the output unit 14. The visible band shade estimation unit 53 estimates (generates) the visible band shaded image on the basis of the supplied feature amount, and supplies the visible band shaded image to the output unit 14.

The visible band diffuse reflectance and shade estimation unit 13B can be implemented by the CNN predictor using the CNN.

According to the image processing device 1 of the second embodiment configured as described above, the visible band diffuse reflectance image and the visible band shaded image are estimated by use of the distance image in addition to the invisible band diffuse reflectance image and the visible band image distance image. Since the distance image reflects shape information on the subject (object) and the shape information is correlated with shade, it can be expected that estimation of the visible band reflectance image and the shaded image is more stably performed. Instead of the distance image, the normal image generated by the normal estimation unit 32 may be input to the visible band diffuse reflectance and shade estimation unit 13B, and the visible band diffuse reflectance image and the visible band shaded image may be estimated by use of the invisible band diffuse reflectance image, the visible band image distance image, and the normal image. Furthermore, both the distance image and the normal image may be input to the visible band diffuse reflectance and shade estimation unit 13B to estimate the visible band diffuse reflectance image and the visible band shaded image.

### 8. THIRD EMBODIMENT OF IMAGE PROCESSING DEVICE

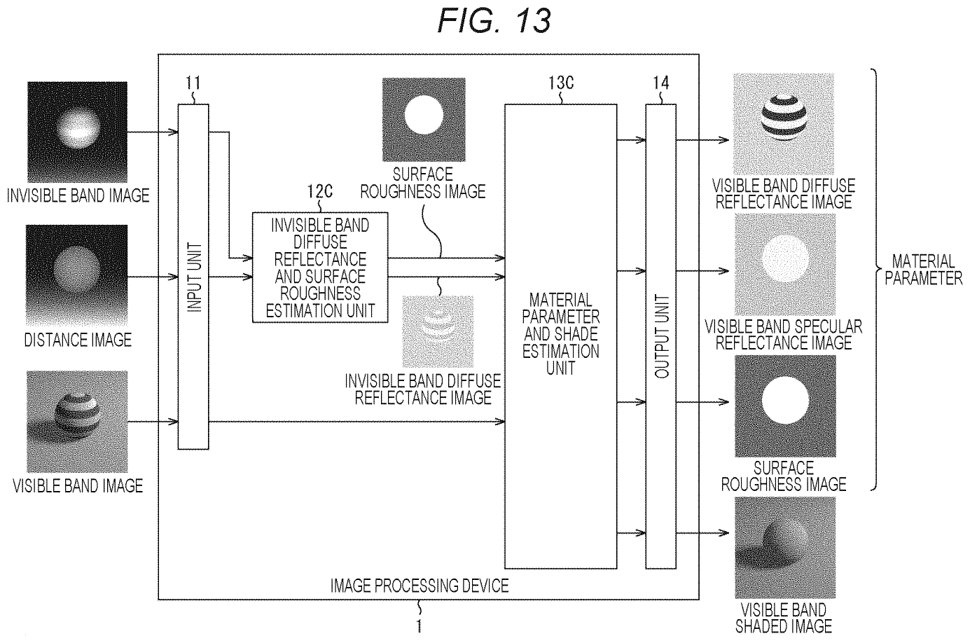

FIG. 13 is a block diagram illustrating a configuration example of a third embodiment of the image processing device of the present disclosure.

In FIG. 13, parts common to those of the image processing device of the first embodiment illustrated in FIG. 1 are denoted with the same reference signs, and descriptions of the parts will be omitted as appropriate.

In the image processing device 1 illustrated in FIG. 13, as compared with the first embodiment illustrated in FIG. 1, the invisible band diffuse reflectance estimation unit 12 and the visible band diffuse reflectance and shade estimation unit 13 are changed to an invisible band diffuse reflectance and surface roughness estimation unit 12C and a material parameter and shade estimation unit 13C.

The image processing device 1 of the third embodiment is configured to estimate and output various material parameters other than the visible band diffuse reflectance. As the material parameter that can be output by the image processing device 1, for example, parameters of the Phong reflection model, which is one of the reflection models used in the CG, are adopted. The parameters of the Phong reflection model include visible band specular reflectance, surface roughness, and the like in addition to the visible band diffuse reflectance described above. Of course, the material parameter may be a parameter necessary for any reflection model other than the Phong reflection model. The Phong reflection model is described in, for example, “Phong, “Illumination for computer generated pictures.” Communications of the ACM 18.6 (1975): p. 311-317″.

The invisible band diffuse reflectance and surface roughness estimation unit 12C is obtained by modification of the invisible band diffuse reflectance estimation unit 12 to estimate a surface roughness image, which is one of the material parameters, in addition to the invisible band diffuse reflectance image. The material parameter and shade estimation unit 13C is obtained by modification of the visible band diffuse reflectance and shade estimation unit 13 to estimate a visible band specular reflectance image, which is a material parameter other than the visible band diffuse reflectance, in addition to the visible band diffuse reflectance.

The invisible band diffuse reflectance and surface roughness estimation unit 12C is common to the invisible band diffuse reflectance estimation unit 12 in that the invisible band diffuse reflectance image is generated from the input invisible band image and distance image. In addition, the invisible band diffuse reflectance and surface roughness estimation unit 12C estimates a surface roughness image, which is one of the material parameters, and outputs the surface roughness image to the material parameter and shade estimation unit 13C. The surface roughness image is an image having a surface roughness of the subject represented by a predetermined number of bit values as a pixel value. The surface roughness, which is one of the material parameters, has an invariable value depending on the wavelength band. For that reason, more stable estimation can be expected when the surface roughness image is obtained with the invisible band image for which the illumination environment is known as an input than when the surface roughness image is obtained with the visible band image for which the illumination environment is unknown as an input. Thus, the invisible band diffuse reflectance and surface roughness estimation unit 12C estimates the invisible band diffuse reflectance image and the surface roughness image and outputs the images to the material parameter and shade estimation unit 13C.

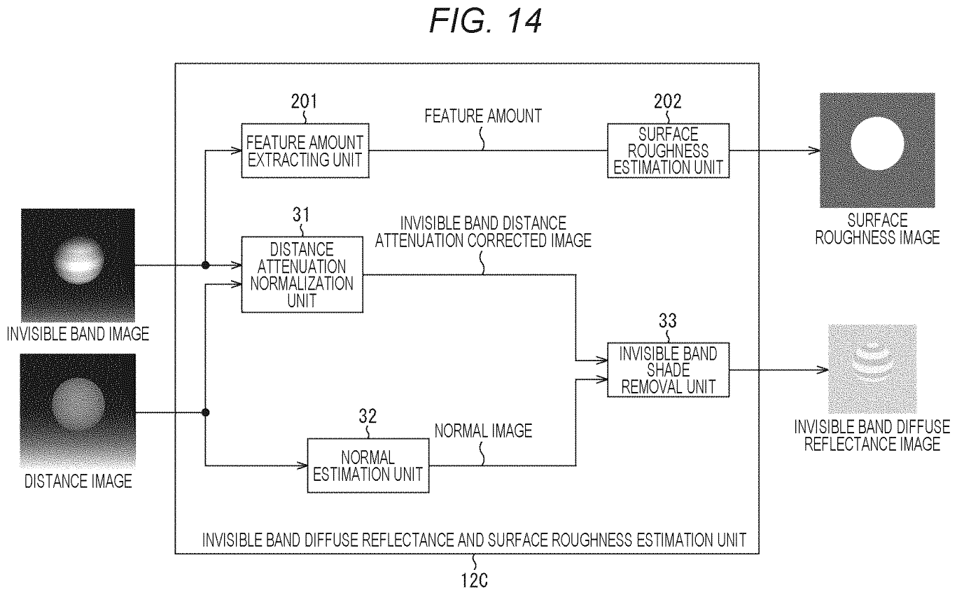

The material parameter and shade estimation unit 13C estimates (generates) and outputs a visible band diffuse reflectance image, a visible band specular reflectance image, and a visible band shaded image on the basis of the visible band image supplied from the input unit 11 and the invisible band diffuse reflectance image and the surface roughness image supplied from the invisible band diffuse reflectance and surface roughness estimation unit 12C. The visible band specular reflectance image is an image having a specular reflectance of the subject with a light source including a visible band as a pixel value. More specifically, the material parameter and shade estimation unit 13C generates and outputs the visible band diffuse reflectance image, the visible band specular reflectance image, and the visible band shaded image by using the invisible band diffuse reflectance image and the visible band image, and as for the surface roughness image, outputs the surface roughness image acquired from the invisible band diffuse reflectance and surface roughness estimation unit 12C as it is. FIG. 14 is a block diagram illustrating a detailed configuration example of the invisible band diffuse reflectance and surface roughness estimation unit 12C.

The invisible band diffuse reflectance and surface roughness estimation unit 12C is newly provided with a feature amount extraction unit 201 and a surface roughness estimation unit 202 in addition to the distance attenuation normalization unit 31, the normal estimation unit 32, and the invisible band shade removal unit 33 in a similar manner to the first embodiment.

The feature amount extraction unit 201 receives as an input the invisible band image. The feature amount extraction unit 201 extracts, from the invisible band image, a feature amount of the image and supplies the feature amount to the surface roughness estimation unit 202. The surface roughness estimation unit 202 estimates (generates) the surface roughness image on the basis of the supplied feature amount, and supplies the surface roughness image to the material parameter and shade estimation unit 13C (FIG. 13).

The feature amount extraction unit 201 and the surface roughness estimation unit 202 can be implemented by the CNN predictor using the CNN. In the learning processing for the CNN predictor, parameters of the CNN predictor are learned by use of a teacher image for the surface roughness image generated by CG or the like, for example.

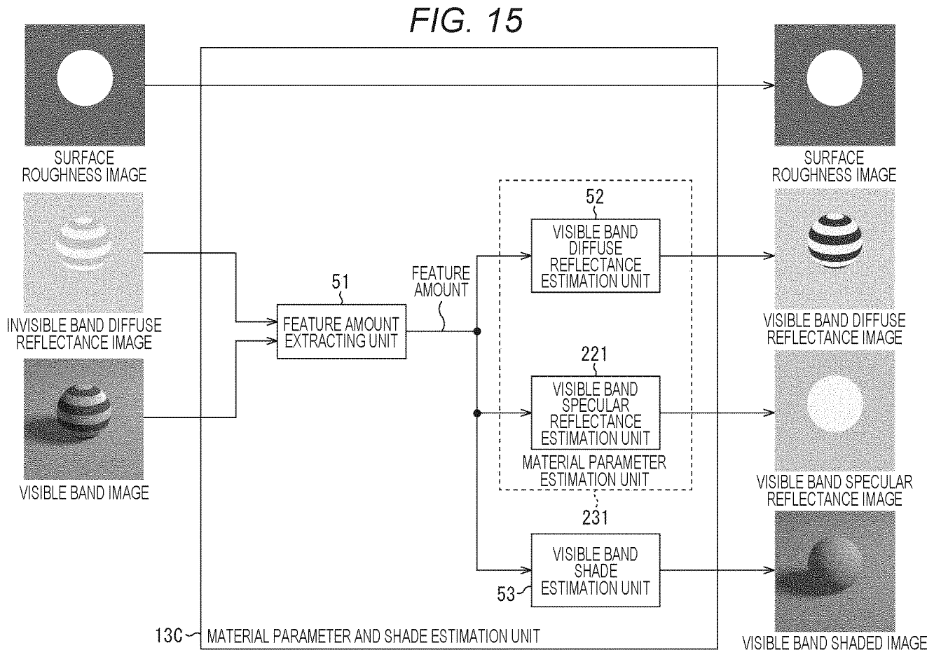

FIG. 15 is a block diagram illustrating a detailed configuration example of the material parameter and shade estimation unit 13C.

The material parameter and shade estimation unit 13C includes the feature amount extraction unit 51, the visible band diffuse reflectance estimation unit 52, the visible band shade estimation unit 53, and a visible band specular reflectance estimation unit 221. As compared with the first embodiment illustrated in FIG. 3, the visible band specular reflectance estimation unit 221 is added. The visible band diffuse reflectance estimation unit 52 and the visible band specular reflectance estimation unit 221 constitute a material parameter estimation unit 231 that estimates a material parameter.

The visible band specular reflectance estimation unit 221 estimates (generates) the visible band specular reflectance image on the basis of the feature amount supplied from the feature amount extraction unit 51, and supplies the visible band specular reflectance image to the output unit 14. The material parameter and shade estimation unit 13C outputs the surface roughness image acquired from the invisible band diffuse reflectance and surface roughness estimation unit 12C as it is.

The material parameter and shade estimation unit 13C can be implemented by the CNN predictor using the CNN. In the learning processing for the CNN predictor, parameters of the CNN predictor are learned by use of teacher images for the invisible band diffuse reflectance image, the visible band specular reflectance image, and the visible band shaded image generated by CG or the like, for example.

According to the image processing device 1 of the third embodiment configured as described above, it is possible to estimate and output the visible band specular reflectance image and the surface roughness image, which are other material parameters, in addition to the visible band diffuse reflectance image and the visible band shaded image. The surface roughness image can be stably estimated with high accuracy by being estimated from the invisible band image for which the illumination environment is known. The visible band specular reflectance image can also be stably estimated with high accuracy by being estimated by use of the invisible band diffuse reflectance image as the guide information.

### 9. FOURTH EMBODIMENT OF IMAGE PROCESSING DEVICE

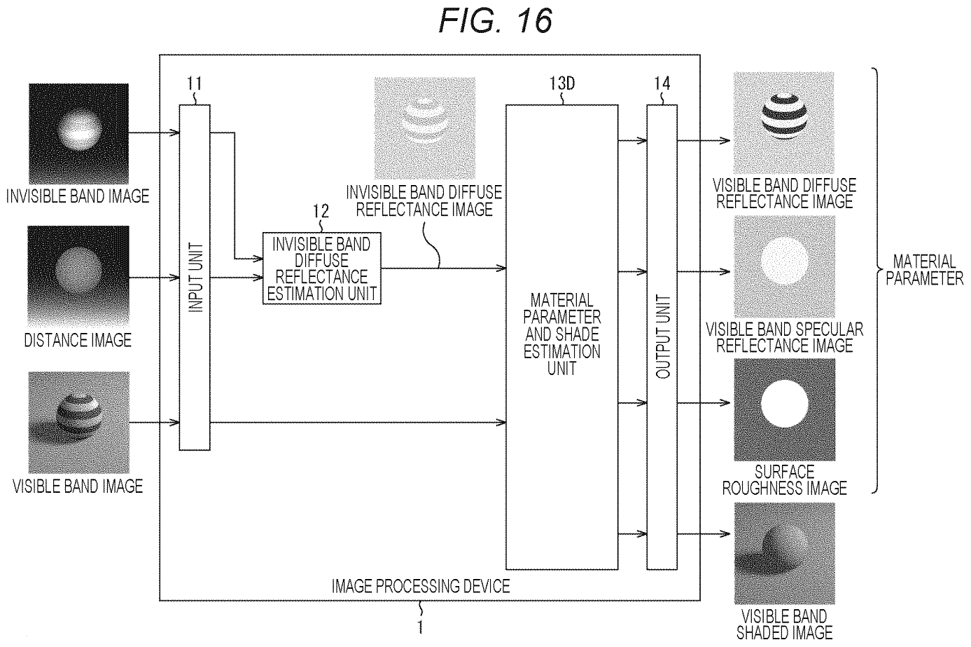

FIG. 16 is a block diagram illustrating a configuration example of a fourth embodiment of the image processing device of the present disclosure.

In FIG. 16, parts common to those of the image processing device of the first embodiment illustrated in FIG. 1 are denoted with the same reference signs, and descriptions of the parts will be omitted as appropriate.

In the image processing device 1 illustrated in FIG. 16, as compared with the first embodiment illustrated in FIG. 1, the visible band diffuse reflectance and shade estimation unit 13 is changed to a material parameter and shade estimation unit 13D. The material parameter and shade estimation unit 13D is obtained by modification of the visible band diffuse reflectance and shade estimation unit 13 to estimate other material parameters in addition to the visible band diffuse reflectance.

The fourth embodiment is common to the third embodiment described above in that the visible band specular reflectance image and the surface roughness image are also estimated and output in addition to the visible band diffuse reflectance image and the visible band shaded image. On the other hand, the surface roughness image is estimated by the invisible band diffuse reflectance and surface roughness estimation unit 12C in the third embodiment, but the fourth embodiment is configured to estimate the surface roughness image by the material parameter and shade estimation unit 13D. That is, the material parameter and shade estimation unit 13D estimates (generates) and outputs the visible band diffuse reflectance image, the visible band specular reflectance image, the surface roughness image, and the visible band shaded image on the basis of the visible band image supplied from the input unit 11 and the invisible band diffuse reflectance image from the invisible band diffuse reflectance estimation unit 12.

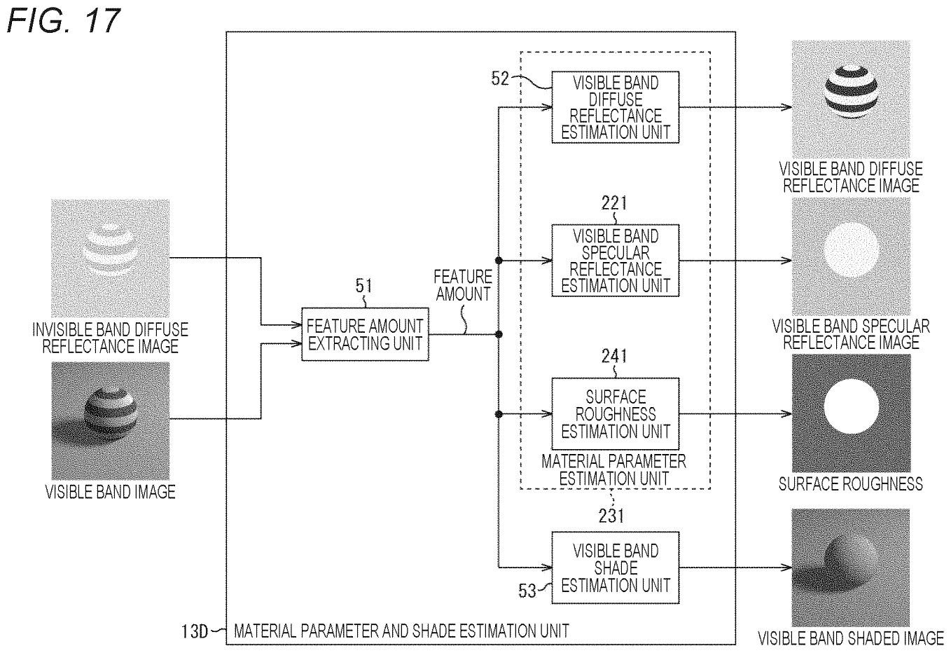

FIG. 17 is a block diagram illustrating a detailed configuration example of the material parameter and shade estimation unit 13D.

The material parameter and shade estimation unit 13D includes the feature amount extraction unit 51, the visible band diffuse reflectance estimation unit 52, the visible band shade estimation unit 53, the visible band specular reflectance estimation unit 221, and a surface roughness estimation unit 241. As compared with the third embodiment illustrated in FIG. 15, the surface roughness estimation unit 241 is newly added. The visible band diffuse reflectance estimation unit 52, the visible band specular reflectance estimation unit 221, and the surface roughness estimation unit 241 constitute the material parameter estimation unit 231. The surface roughness estimation unit 241 estimates (generates) the surface roughness image on the basis of the supplied feature amount, and supplies the surface roughness image to the output unit 14.

The material parameter and shade estimation unit 13D can be implemented by the CNN predictor using the CNN. In the learning processing for the CNN predictor, parameters of the CNN predictor are learned by use of teacher images for the invisible band diffuse reflectance image, the visible band specular reflectance image, the surface roughness image, and the visible band shaded image generated by CG or the like, for example.

According to the image processing device 1 of the fourth embodiment configured as described above, it is possible to estimate and output the visible band specular reflectance image and the surface roughness image in addition to the visible band diffuse reflectance image and the visible band shaded image. The visible band specular reflectance and the surface roughness are material parameters other than the visible band diffuse reflectance. These material parameters can also be stably estimated with high accuracy by being estimated by use of the invisible band diffuse reflectance image as the guide information.

### 10. CONCLUSION

The image processing device 1 described above includes:
an input unit that receives, as inputs, a first wavelength band image obtained by imaging of a subject under an unknown light source environment including a first wavelength band, a second wavelength band image obtained by imaging of the subject under a known light source environment including a second wavelength band, and a distance image of the subject;
a second wavelength diffuse reflectance estimation unit that estimates, from the second wavelength band image and the distance image, a second wavelength diffuse reflectance image that is a diffuse reflectance image of the subject with a light source in the second wavelength band; and
a first wavelength diffuse reflectance and shade estimation unit that estimates a first wavelength diffuse reflectance image and a first wavelength shaded image that are a diffuse reflectance image and a shaded image of the subject with a light source including the first wavelength band on the basis of the second wavelength diffuse reflectance image and the first wavelength band image.

In the above-described embodiment, the light in the RGB wavelength band in the range of 400 to 700 nm is used as the light in the first wavelength band, and the first wavelength band image is the visible band image. Furthermore, as light in the second wavelength band, the light in the infrared light wavelength band in the range of 780 to 1000 nm is used, and the second wavelength band image is the invisible band image.

That is, the image processing device 1 of the above-described embodiment includes:
the input unit 11 that receives, as inputs, a visible band image obtained by imaging of a subject under an unknown light source environment including a visible band, an invisible band image obtained by imaging of the subject under a known light source environment including an invisible band, and a distance image of the subject;
the invisible band diffuse reflectance estimation unit 12, 12B, or 12C that estimates an invisible band diffuse reflectance image that is a diffuse reflectance image of the subject with a light source in the invisible band from the invisible band image and the distance image; and
the visible band diffuse reflectance and shade estimation unit 13, 13B, 13C, or 13D that estimates a visible band diffuse reflectance image and a visible band shaded image that are a diffuse reflectance image and a shaded image of the subject with a light source including the visible band on the basis of the invisible band diffuse reflectance image and the visible band image.

By estimating the invisible band diffuse reflectance image from the invisible band image and the distance image and using the invisible band diffuse reflectance image as guide information when estimating the visible band diffuse reflectance image and the visible band shaded image, it is possible to stably implement separation of the input visible band image into the visible band diffuse reflectance image and the visible band shaded image with high accuracy. By using a light source of infrared light in the invisible band as the known light source, it is possible to reduce discomfort of the presence or absence of light emission (flash) since the light emission is not visible to human eyes.

The present technology is not limited to a case where the first wavelength band and the second wavelength band are separated as visible band light and invisible band light. For example, a light source environment including the light in the first wavelength band for the first wavelength band image may be a light source environment of visible light and infrared light in a range of 400 to 850 nm, and a light source environment including the light in the second wavelength band for the second wavelength band image may be a light source environment of infrared light in the vicinity of 850 nm. Alternatively, the light source environment including the light in the first wavelength band for the first wavelength band image may be a light source environment of infrared light in the vicinity of 850 nm, and the light source environment including the light in the second wavelength band for the second wavelength band image may be a light source environment of infrared light in the vicinity of 940 nm.

The image processing system 70 includes: a first imaging device that images a subject under an unknown light source environment including a first wavelength band (for example, a visible band); a second imaging device that images the subject under a known light source environment including a second wavelength band (for example, an invisible band); and the image processing device 1 that estimates a first wavelength diffuse reflectance image and a first wavelength shaded image that are a diffuse reflectance image and a shaded image of the subject with a light source including the first wavelength band. The first imaging device corresponds to the visible band camera 83 in the above-described embodiment, and the second imaging device corresponds to the invisible band camera system 81, the invisible band camera system 81′, or the iToF module 101. In a case where the second imaging device is the invisible band camera system 81 and the second imaging device generates only the second wavelength band image (visible band image), the depth camera 82 that generates a distance image can be provided as a third imaging device. In a case where the second imaging device is the iToF module 101 or the invisible band camera system 81′ and generates the second wavelength band image (invisible band image) and the distance image, the depth camera 82 as the third imaging device is unnecessary, and implementation can be performed with a simpler device configuration.

In the above-described embodiment, an example has been described in which the visible band image generated by the first imaging device is a color image, but the visible band image may be a monochrome image.

### 11. CONFIGURATION EXAMPLE OF COMPUTER

A series of processing performed by the image processing device 1 and the image processing unit 93 (93′) described above can be executed by hardware or software. In a case where the series of processing is executed by software, a program constituting the software is installed in a computer. Here, examples of the computer include, for example, a microcomputer that is incorporated in dedicated hardware, a general-purpose personal computer that can execute various functions by installation of various programs, and the like.

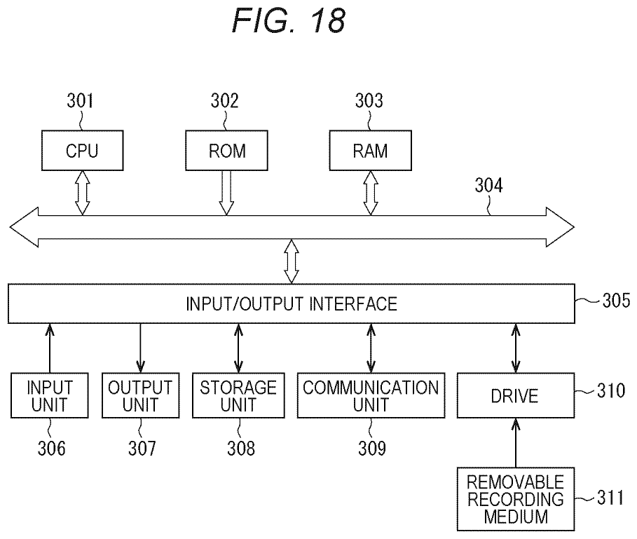

FIG. 18 is a block diagram illustrating a configuration example of hardware of the computer that executes the series of processing described above in accordance with the program.

In the computer, a central processing unit (CPU) 301, a read only memory (ROM) 302, and a random access memory (RAM) 303 are connected to each other by a bus 304.

The bus 304 is further connected to an input/output interface 305. The input/output interface 305 is connected to an input unit 306, an output unit 307, a storage unit 308, a communication unit 309, and a drive 310.

The input unit 306 includes a keyboard, a mouse, a microphone, a touch panel, an input terminal, and the like. The output unit 307 includes a display, a speaker, an output terminal, and the like. The storage unit 308 includes a hard disk, a RAM disk, a non-volatile memory, or the like. The communication unit 309 includes a network interface and the like. The drive 310 drives a removable recording medium 311 such as a magnetic disk, an optical disk, a magneto-optical disk, or a semiconductor memory.

In the computer configured as described above, the above-described series of processing is executed, for example, by the CPU 301 loading the program stored in the storage unit 308 into the RAM 303 via the input/output interface 305 and the bus 304 and executing the program. The RAM 303 also stores, as appropriate, data and the like necessary for the CPU 301 to execute the various types of processing.

The program to be executed by the computer (CPU 301) can be recorded on the removable recording medium 311 as a package medium or the like, for example, and be provided. Furthermore, the program can be provided via a wired or wireless transmission medium such as a local area network, the Internet, or digital satellite broadcasting.

In the computer, the program can be installed into the storage unit 308 via the input/output interface 305 when the removable recording medium 311 is mounted to the drive 310. Furthermore, the program can be received by the communication unit 309 via the wired or wireless transmission medium to be installed in the storage unit 308. Besides, the program can be installed in advance on the ROM 302 and the storage unit 308.

Note that, in the present specification, the steps described in the flowcharts may be executed not only, needless to say, in time series in the described order, but also in parallel or as needed at a timing when a call is made, or the like, even if not processed in time series.

Embodiments of the present disclosure are not limited to the above-described embodiments, and various modifications may be made without departing from the scope of the technology of the present disclosure.

For example, it is possible to adopt a mode obtained by combining all or some of the plurality of embodiments described above.

For example, the technology according to the present disclosure can provide a configuration of cloud computing in which one function is shared and processed by a plurality of devices cooperating with each other via a network.

Furthermore, each step described in the flowchart described above can be performed by one device or can be performed by a plurality of devices in a shared manner.

Moreover, in a case where one step includes a plurality of pieces of processing, the plurality of pieces of processing included in the one step can be performed by one device or performed by a plurality of devices in a shared manner.

Note that the effects described in the present specification are merely examples and are not restrictive, and there may be effects other than those described in the present specification.

Note that the technology of the present disclosure can have the following configurations.
(1)
An image processing device including:
an input unit that receives, as inputs, a first wavelength band image obtained by imaging of a subject under an unknown light source environment including a first wavelength band, a second wavelength band image obtained by imaging of the subject under a known light source environment including a second wavelength band, and a distance image of the subject;
a second wavelength diffuse reflectance estimation unit that estimates, from the second wavelength band image and the distance image, a second wavelength diffuse reflectance image that is a diffuse reflectance image of the subject with a light source in the second wavelength band; and
a first wavelength diffuse reflectance and shade estimation unit that estimates a first wavelength diffuse reflectance image and a first wavelength shaded image that are a diffuse reflectance image and a shaded image of the subject with a light source including the first wavelength band on the basis of the second wavelength diffuse reflectance image and the first wavelength band image.
(2)
The image processing device according to (1), in which
the first wavelength band is a visible band, and
the second wavelength band is an invisible band.
(3)
The image processing device according to (2), in which
the invisible band is an infrared light wavelength band.
(4)
The image processing device according to any of (1) to (3), in which
the second wavelength diffuse reflectance estimation unit
includes:
a distance attenuation normalization unit that generates, from the second wavelength band image and the distance image, a second wavelength band distance attenuation corrected image that is an image obtained by correction of an influence of distance attenuation with respect to the second wavelength band image;
a normal estimation unit that estimates a normal image on the basis of the distance image; and
a shade removal unit that removes shade from the second wavelength band distance attenuation corrected image by using the normal image and generates the second wavelength diffuse reflectance image.
(5)
The image processing device according to any of (1) to (4), in which
the first wavelength diffuse reflectance and shade estimation unit
includes:
a feature amount extraction unit that extracts a feature amount from the second wavelength diffuse reflectance image and the first wavelength band image;
a first wavelength diffuse reflectance estimation unit that estimates the first wavelength diffuse reflectance image on the basis of the feature amount; and
a first wavelength shade estimation unit that estimates the first wavelength shaded image on the basis of the feature amount.
(6)
The image processing device according to any of (1) to (5), in which
the first wavelength diffuse reflectance and shade estimation unit includes a CNN predictor.
(7)
The image processing device according to any of (1) to (5), in which
the first wavelength diffuse reflectance and shade estimation unit is configured to cause calculation to be performed on the basis of a condition that relationships between pixel values of adjacent pixels are close to each other between the second wavelength diffuse reflectance image and the first wavelength diffuse reflectance image.
(8)
The image processing device according to any of (1) to (3), and (6), in which
the first wavelength diffuse reflectance and shade estimation unit estimates the first wavelength diffuse reflectance image and the first wavelength shaded image on the basis of the distance image in addition to the second wavelength diffuse reflectance image and the first wavelength band image.
(9)
The image processing device according to (8), in which
the first wavelength diffuse reflectance and shade estimation unit
includes:
a feature amount extraction unit that extracts a feature amount from the second wavelength diffuse reflectance image, the distance image, and the first wavelength band image;
a first wavelength diffuse reflectance estimation unit that estimates the first wavelength diffuse reflectance image on the basis of the feature amount; and
a first wavelength shade estimation unit that estimates the first wavelength shaded image on the basis of the feature amount.
(10)
The image processing device according to any of (1) to (3), and (6), in which
the second wavelength diffuse reflectance estimation unit estimates, from the second wavelength band image and the distance image, a surface roughness image of the subject in addition to the second wavelength diffuse reflectance image.
(11)
The image processing device according to any of (1) to (3), (6), and (10), in which
the first wavelength diffuse reflectance and shade estimation unit estimates a first wavelength specular reflectance image that is a specular reflectance image of the subject with a light source including the first wavelength band in addition to the first wavelength diffuse reflectance image and the first wavelength shaded image on the basis of the second wavelength diffuse reflectance image and the first wavelength band image.
(12)
The image processing device according to (11), in which
the first wavelength diffuse reflectance and shade estimation unit
includes:
a feature amount extraction unit that extracts a feature amount from the second wavelength diffuse reflectance image and the first wavelength band image;
a first wavelength diffuse reflectance estimation unit that estimates the first wavelength diffuse reflectance image on the basis of the feature amount;
a first wavelength shade estimation unit that estimates the first wavelength shaded image on the basis of the feature amount; and
a first wavelength specular reflectance estimation unit that estimates the first wavelength specular reflectance image on the basis of the feature amount.
(13)
The image processing device according to any of (1) to (3) and (6), in which
the first wavelength diffuse reflectance and shade estimation unit estimates a surface roughness image of the subject and a first wavelength specular reflectance image that is a specular reflectance image of the subject with a light source including the first wavelength band in addition to the first wavelength diffuse reflectance image and the first wavelength shaded image on the basis of the second wavelength diffuse reflectance image and the first wavelength band image.
(14) The image processing device according to (13), in which
the first wavelength diffuse reflectance and shade estimation unit
includes:
a feature amount extraction unit that extracts a feature amount from the second wavelength diffuse reflectance image and the first wavelength band image;
a first wavelength diffuse reflectance estimation unit that estimates the first wavelength diffuse reflectance image on the basis of the feature amount;
a first wavelength shade estimation unit that estimates the first wavelength shaded image on the basis of the feature amount;
a first wavelength specular reflectance estimation unit that estimates the first wavelength specular reflectance image on the basis of the feature amount; and
a first wavelength surface roughness image estimation unit that estimates the surface roughness image on the basis of the feature amount.
(15) An image processing system including:
a first imaging device that images a subject under an unknown light source environment including a first wavelength band;
a second imaging device that images the subject under a known light source environment including a second wavelength band; and
an image processing device that estimates a first wavelength diffuse reflectance image and a first wavelength shaded image that are a diffuse reflectance image and a shaded image of the subject with a light source including the first wavelength band by using a first wavelength band image obtained by imaging of the subject by the first imaging device, a second wavelength band image obtained by imaging of the subject by the second imaging device, and a distance image of the subject.
(16)
The image processing system according to (15), in which
the first imaging device generates the first wavelength band image and a front distance image and outputs the first wavelength band image and the front distance image to the image processing device.
(17)
The image processing system according to (15), in which
the second imaging device generates the second wavelength band image and a front distance image and outputs the second wavelength band image and the front distance image to the image processing device.
(18)
The image processing system according to (17), in which
the second imaging device is a distance measurement module that generates the second wavelength band image and the distance image by an indirect ToF method.
(19) The image processing system according to (15), further including
a third imaging device that generates the distance image and outputs the distance image to the image processing device.

### REFERENCE SIGNS LIST

1 Image processing device
11 Input unit
12, 12B Invisible band diffuse reflectance estimation unit
12C Invisible band diffuse reflectance and surface roughness estimation unit
13, 13B Visible band diffuse reflectance and shade estimation unit
13C, 13D Material parameter and shade estimation unit
14 Output unit
31 Distance attenuation normalization unit
32 Normal estimation unit
33 Invisible band shade removal unit
51, 51B Feature amount extraction unit
52 Visible band diffuse reflectance estimation unit
53 Visible band shade estimation unit
70 Image processing system
81, 81′ Invisible band camera system
82 Depth camera
83 Visible band camera
84 Control device
91 Invisible band light source
92, 92′ Invisible band camera
93, 93′ Image processing unit
101 iToF module
111 Invisible band light source
112 iToF sensor
201 Feature amount extraction unit
202 Surface roughness estimation unit
221 Visible band specular reflectance estimation unit
231 Material parameter estimation unit
241 Surface roughness estimation unit
301 CPU
302 ROM
303 RAM
306 Input unit
307 Output unit
308 Storage unit
309 Communication unit
310 Drive

1. An image processing device comprising:
an input unit that receives, as inputs, a first wavelength band image obtained by imaging of a subject under an unknown light source environment including a first wavelength band, a second wavelength band image obtained by imaging of the subject under a known light source environment including a second wavelength band, and a distance image of the subject;
a second wavelength diffuse reflectance estimation unit that estimates, from the second wavelength band image and the distance image, a second wavelength diffuse reflectance image that is a diffuse reflectance image of the subject with a light source in the second wavelength band; and
a first wavelength diffuse reflectance and shade estimation unit that estimates a first wavelength diffuse reflectance image and a first wavelength shaded image that are a diffuse reflectance image and a shaded image of the subject with a light source including the first wavelength band on a basis of the second wavelength diffuse reflectance image and the first wavelength band image.

2. The image processing device according to claim 1, wherein
the first wavelength band is a visible band, and
the second wavelength band is an invisible band.

3. The image processing device according to claim 2, wherein
the invisible band is an infrared light wavelength band.

4. The image processing device according to claim 1, wherein
the second wavelength diffuse reflectance estimation unit
includes:
a distance attenuation normalization unit that generates, from the second wavelength band image and the distance image, a second wavelength band distance attenuation corrected image that is an image obtained by correction of an influence of distance attenuation with respect to the second wavelength band image;
a normal estimation unit that estimates a normal image on a basis of the distance image; and
a shade removal unit that removes shade from the second wavelength band distance attenuation corrected image by using the normal image and generates the second wavelength diffuse reflectance image.

5. The image processing device according to claim 1, wherein
the first wavelength diffuse reflectance and shade estimation unit
includes:
a feature amount extraction unit that extracts a feature amount from the second wavelength diffuse reflectance image and the first wavelength band image;
a first wavelength diffuse reflectance estimation unit that estimates the first wavelength diffuse reflectance image on a basis of the feature amount; and
a first wavelength shade estimation unit that estimates the first wavelength shaded image on a basis of the feature amount.

6. The image processing device according to claim 1, wherein
the first wavelength diffuse reflectance and shade estimation unit includes a CNN predictor.

7. The image processing device according to claim 1, wherein
the first wavelength diffuse reflectance and shade estimation unit is configured to cause calculation to be performed on a basis of a condition that relationships between pixel values of adjacent pixels are close to each other between the second wavelength diffuse reflectance image and the first wavelength diffuse reflectance image.

8. The image processing device according to claim 1, wherein
the first wavelength diffuse reflectance and shade estimation unit estimates the first wavelength diffuse reflectance image and the first wavelength shaded image on a basis of the distance image in addition to the second wavelength diffuse reflectance image and the first wavelength band image.

9. The image processing device according to claim 8, wherein
the first wavelength diffuse reflectance and shade estimation unit
includes:
a feature amount extraction unit that extracts a feature amount from the second wavelength diffuse reflectance image, the distance image, and the first wavelength band image;
a first wavelength diffuse reflectance estimation unit that estimates the first wavelength diffuse reflectance image on a basis of the feature amount; and
a first wavelength shade estimation unit that estimates the first wavelength shaded image on a basis of the feature amount.

10. The image processing device according to claim 1, wherein
the second wavelength diffuse reflectance estimation unit estimates, from the second wavelength band image and the distance image, a surface roughness image of the subject in addition to the second wavelength diffuse reflectance image.

11. The image processing device according to claim 1, wherein
the first wavelength diffuse reflectance and shade estimation unit estimates a first wavelength specular reflectance image that is a specular reflectance image of the subject with a light source including the first wavelength band in addition to the first wavelength diffuse reflectance image and the first wavelength shaded image on a basis of the second wavelength diffuse reflectance image and the first wavelength band image.

12. The image processing device according to claim 11, wherein
the first wavelength diffuse reflectance and shade estimation unit
includes:
a feature amount extraction unit that extracts a feature amount from the second wavelength diffuse reflectance image and the first wavelength band image;
a first wavelength diffuse reflectance estimation unit that estimates the first wavelength diffuse reflectance image on a basis of the feature amount;
a first wavelength shade estimation unit that estimates the first wavelength shaded image on a basis of the feature amount; and
a first wavelength specular reflectance estimation unit that estimates the first wavelength specular reflectance image on a basis of the feature amount.

13. The image processing device according to claim 1, wherein
the first wavelength diffuse reflectance and shade estimation unit estimates a surface roughness image of the subject and a first wavelength specular reflectance image that is a specular reflectance image of the subject with a light source including the first wavelength band in addition to the first wavelength diffuse reflectance image and the first wavelength shaded image on a basis of the second wavelength diffuse reflectance image and the first wavelength band image.

14. The image processing device according to claim 13, wherein
the first wavelength diffuse reflectance and shade estimation unit
includes:
a feature amount extraction unit that extracts a feature amount from the second wavelength diffuse reflectance image and the first wavelength band image;
a first wavelength diffuse reflectance estimation unit that estimates the first wavelength diffuse reflectance image on a basis of the feature amount;
a first wavelength shade estimation unit that estimates the first wavelength shaded image on a basis of the feature amount;
a first wavelength specular reflectance estimation unit that estimates the first wavelength specular reflectance image on a basis of the feature amount; and
a first wavelength surface roughness image estimation unit that estimates the surface roughness image on a basis of the feature amount.

15. An image processing system comprising:
a first imaging device that images a subject under an unknown light source environment including a first wavelength band;
a second imaging device that images the subject under a known light source environment including a second wavelength band; and
an image processing device that estimates a first wavelength diffuse reflectance image and a first wavelength shaded image that are a diffuse reflectance image and a shaded image of the subject with a light source including the first wavelength band by using a first wavelength band image obtained by imaging of the subject by the first imaging device, a second wavelength band image obtained by imaging of the subject by the second imaging device, and a distance image of the subject.

16. The image processing system according to claim 15, wherein
the first imaging device generates the first wavelength band image and a front distance image and outputs the first wavelength band image and the front distance image to the image processing device.

17. The image processing system according to claim 15, wherein
the second imaging device generates the second wavelength band image and a front distance image and outputs the second wavelength band image and the front distance image to the image processing device.

18. The image processing system according to claim 17, wherein
the second imaging device is a distance measurement module that generates the second wavelength band image and the distance image by an indirect ToF method.

19. The image processing system according to claim 15, further comprising
a third imaging device that generates the distance image and outputs the distance image to the image processing device.
